(19) United States
(12) Patent Application Publication
(10) Pub. No.: US 2021/0401200 A1
(43) Pub. Date: Dec. 30, 2021

(54) SPINNING CUP

(71) Applicant: STARBI TOYS, LLC, Houston, TX (US)

(72) Inventor: Luke Bryan Lumpkin, Houston, TX (US)

(21) Appl. No.: 17/364,244

(22) Filed: Jun. 30, 2021

Related U.S. Application Data
(60) Provisional application No. 63/102,770, filed on Jun. 30, 2020.

(51) Int. Cl. A47G 19/22; B01F 13/00; A63H 33/00

(52) U.S. Cl. CPC A47G 19/2227; A63H 33/00; B01F 13/0022

(57) ABSTRACT

A cup having an external wall with an external bottom, an internal wall with an internal bottom, and a spinner wall between the external wall and the internal wall. The spinner wall can be provided with weighted modules. An actuator can be placed in between the external bottom and internal bottom of the cup and connected to the spinner wall. A user can spin the spinning cup by slightly flicking the weighted modules or the spinner wall. Graphics can be applied to the spinner wall to create a visual illusion or picture when spinning.

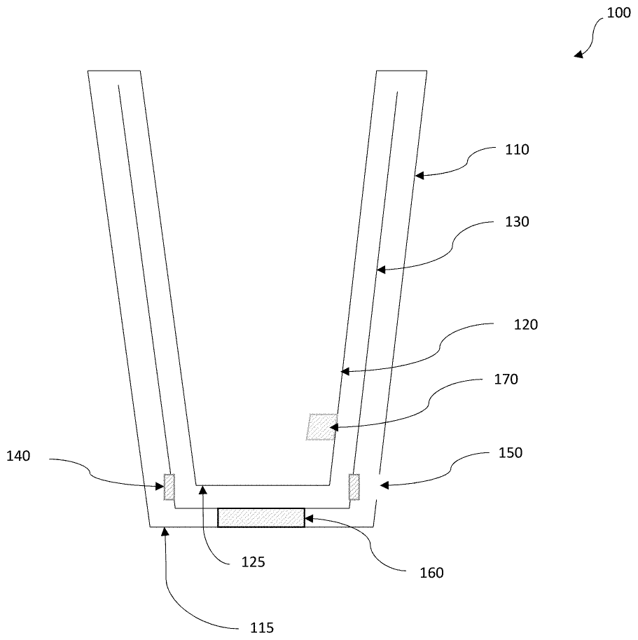

### CROSS REFERENCE TO RELATED APPLICATIONS

The current application claims priority to and the benefit of co-pending U.S. Provisional Patent Application Ser. No. 63/102,770 filed on Jun. 30, 2020, titled “Spinning Cup”. This reference is incorporated herein in its entirety.

### FIELD

The present disclosure generally relates to a cup with a spinning element for holding consumables.

### BACKGROUND

A number of apparatus known as “fidget toys” have been promoted for helping people focus or to relieve anxiety and stress. Many believe these toys to aid those with autism or attention deficit hyperactivity disorder (ADHD).

These fidget toys are often spinning elements, or have other push buttons, switches, or other elements to keep people occupied. Whether effective as treatments or not, these toys are widely appreciated by children and adults.

The present disclosure provides a cup for drinking liquids, or holding snacks which has a visual and palpable mechanism for a user to manipulate.

### BRIEF DESCRIPTION OF THE DRAWINGS

The detailed description will be better understood in conjunction with the accompanying drawing as follows:

The FIGURE depicts a schematic representation of an embodiment of the present disclosure.

The embodiments of the present disclosure are detailed below with reference to the FIGURE.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a cup with a spinning element for holding consumables.

The cup can have an external wall having an external bottom, an internal wall having an internal bottom, a spinner wall disposed between the external wall and the internal wall, and an actuator disposed between the internal bottom and the external bottom in mechanical communication with the spinner wall.

In embodiments, the cup can be any kind of cup known in the industry, which can include but is not limited to a tumbler, a plastic cup, a glass cup, a mug, a pint glass, or any other suitable drinkware.

A plurality of weighted modules can be attached to the spinner wall. One or more finger holes can be present in the external wall to allow access to the weighted modules or the spinner wall. The spinner wall can be rotated by a user by flicking one of the weighted modules. For the purposes of this disclosure, flicking the spinner wall will be considered the same action as flicking the weighted module.

In embodiments, the spinner wall can have a picture, a design, a logo, or a pattern. In embodiments, at least a portion of the external wall can be transparent to allow for the spinner wall to be visible.

The weighted modules can be recessed so as not to drag on the external wall, the internal wall, or any other surface such as a cup holder. The weighted modules can be distributed on the spinner wall to allow for the spinner wall to spin when the cup is upright and stationary. In embodiments, the weighted modules can be offset such that swinging the spinning cup in a rhythm will allow the spinner wall to continue spinning.

The internal wall can be constructed of food grade material, to hold liquids or snacks.

Any actuator known to persons having ordinary skill in the art can be used to allow for the spinner wall to spin. In embodiments, the actuator can be a typical bearing, such as a roller ball bearing or a motor. Persons having ordinary skill in the art can select the actuator to minimize friction and maximize spin time of the spinner wall.

In embodiments, the actuator can include a motor assembly, which can be in communication with a power supply and power switch to spin the spinner wall of the cup automatically once the power switch is turned on.

In embodiments, the cup can further comprise a wall paddle disposed on the internal wall section to agitate liquid. This can aid in mixing liquid when the cup is spun, rotated, or shaken. Any paddle, fin, or mixing apparatus known to persons having ordinary skill in the art can be disposed upon the inner wall for this purpose.

In embodiments, the cup can have threads on the upper portion of the external wall or the internal wall for receiving a lid. In embodiments, the lid can be snapped or suctioned into place on top of the cup. The lid can have magnets disposed therein to enable and secure an additional cup, tray, or holder to be stacked on top of the cup.

Turning now to the FIGURE, the FIGURE shows a schematic representation of the spinning cup.

The spinning cup 100 can have an external wall 110 having an external bottom 115, an internal wall 120 having an internal bottom 125, a spinner wall 130 disposed between the external wall 110 and the internal wall 120, and an actuator 160 disposed between the internal bottom 125 and the external bottom 115, which can be in mechanical communication with the spinner wall 130.

The spinner wall 130 can have a plurality of weighted modules 140. The spinner wall can spin when the weighted module (or the spinner wall itself) is flicked by a user through a finger hole 150.

The internal wall 120 can have a wall paddle 170 or mixing device to agitate liquid inside the cup.

Various pictures, patterns, logos, or designs can be incorporated onto spinner wall 130.

In embodiments, the external wall 110 can be transparent to allow the user to see the spinner wall.

While the present disclosure emphasizes the presented embodiment and FIGURE, it should be understood that within the scope of the appended claims, the disclosure might be embodied other than as specifically enabled herein.

What is claimed is:

1. A spinning cup, comprising:
a. an external wall having an external bottom;
b. an internal wall having an internal bottom;
c. a spinner wall disposed between the external wall and the internal wall; and
d. an actuator disposed between the internal bottom and the external bottom in mechanical communication with the spinner wall.

2. The spinning cup of claim 1, further comprising a plurality of weighted modules attached to the spinner wall.

3. The spinning cup of claim 1, wherein the internal wall is constructed of food grade material.

4. The spinning cup of claim 1, wherein the external wall is transparent.

5. The spinning cup of claim 2, wherein the weighted modules are accessible through a finger hole, wherein the finger hole is in the external wall.

6. The spinning cup of claim 2, wherein the weighted modules are recessed so as to not drag on the external wall, the internal wall, a surface, or in a cup holder.

7. The spinning cup of claim 2, wherein the spinner wall section spins when weighted modules are flicked by a user.

8. The spinning cup of claim 2, further comprising a wall paddle disposed on the internal wall section to agitate liquid.

9. The spinning cup of claim 4, wherein the spinner wall comprises a pattern or picture visible through the external wall.
